(19) United States
(12) Patent Application Publication
(10) Pub. No.: US 2013/0057277 A1
(43) Pub. Date: Mar. 7, 2013

(54) Method for Determining Rock Formation Fluid Interaction Properties Using Nuclear Magnetic Resonance Well Logging Measurements

(71) Applicants: Lukasz Zielinski, Houston, TX (US); Martin D. Hürlimann (Hurlimann), Newton, MA (US); Philip Singer, Richmond, TX (US); Raghu Ramamoorthy, Abu-Dhabi (AE)

(72) Inventors: Lukasz Zielinski, Houston, TX (US); Martin D. Hürlimann (Hurlimann), Newton, MA (US); Philip Singer, Richmond, TX (US); Raghu Ramamoorthy, Abu-Dhabi (AE)

(21) Appl. No.: 13/574,670

(22) PCT Filed: Jan. 21, 2011
(86) PCT No.: PCT/US11/22079

§ 371 Date: Nov. 14, 2012

Related U.S. Application Data
(60) Provisional application No. 61/297,581, filed on Jan. 22, 2010.
(60) Provisional application No. 61/297,565, filed on Jan. 22, 2010.

(51) Int. Cl. G01V 3/32

(52) U.S. Cl. 324/303

(57) ABSTRACT

A method for determining surface relaxivity of a rock formation in a wellbore includes using measurements of nuclear magnetic resonance properties of the rock formation made from within a wellbore penetrating the rock formations includes determining nuclear magnetic relaxation properties from the measurements of the nuclear magnetic resonance properties. A diffusion property of the rock formation is determined from the measurements of the nuclear magnetic resonance properties. The surface relaxivity of the rock formation is determined from the relaxation properties and the diffusion property. The surface relaxivity and other nuclear magnetic resonance properties are used to infer wettability and/or fluid saturation of the rock formations.

### CROSS-REFERENCE TO RELATED APPLICATIONS

This application claims priority from U.S. Provisional Applications Nos. 61/297,581 filed on Jan. 22, 2010 and 61/297,565 filed on Jan. 22, 2010.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of subsurface formation evaluation using well logging measurements. More specifically, the invention relates to methods for determining physical properties of rock formations using nuclear magnetic resonance (“NMR”) well logging measurements.

2. Background Art

Wellbores are drilled through subsurface rock formations for, among other purposes, extraction of useful fluids such as oil and gas from porous, permeable rock formations penetrated by such wellbores. The porous formations include rock mineral grains of various shapes and sizes, wherein the grains are bound to each other (cemented) in varying degrees depending on the post depositional history of the particular rock formation. The fluids are contained in the pore spaces. A wellbore is said to be “completed” when hydraulic connection is made between a formation that is intended to produce fluid and the Earth's surface using various conduits and flow control devices.

It is important to understand what fractional amounts of water and oil are considered to “wet” the surface of the rock grains, that is, to be in contact with the grains and so held by capillary pressure. Such information is important in determining the likely future fluid production from the formation, because the wetting phase is to some extent immobile under ordinary producing conditions.

Wettability may be determined by obtaining samples of the rock formations at in situ pressure, temperature and fluid saturation conditions. A sample of the rock formation can be easily obtained from a producing well in which a substantial volume of sand moves into the wellbore. However, the produced sand sample will generally have a higher percentage of fine-grained sand than what is originally present in the rock formation. This is because coarse sand particles tend to fall, rather than move upward to the surface, and settle at the bottom of the well when the sand moves into the wellbore. For the same reason, a bailed sample will generally have a higher fraction of coarse sand than what is present in the reservoir rock. Sand samples obtained from sidewall (percussion or drilled) cores can also give misleading results, particularly in the case of percussion sidewall cores. When the sample taking projectiles strike the face of the formation, they can crush the rock grains, generating more fine particles than may be present in the undisturbed rock formation. The sidewall core sample could also contain drilling fluid (“mud”) solids that can be misidentified as formation material. The most representative formation sample is obtained from conventional (drilled) cores. However, such samples are not readily available in most cases due to cost of coring operations. If drilled core samples are available, small plugs can be taken out of the core at various longitudinal positions along such sample for a complete and accurate characterization of rock properties.

Nuclear magnetic resonance measurements (NMR) made in a wellbore are known in the art for estimating the fractional volume of rock pore space filled with water and filled with hydrocarbons (called “fluid saturation” for each fluid). The methods known in the art use inversion of measurements of diffusion properties of the fluids in the formation pore space and measurements of nuclear magnetic resonance relaxation properties to estimate hydrocarbon and water saturation. The techniques known in the art tend to overestimate hydrocarbon saturation because of difficulties in obtaining correct values for the diffusion constant, in particular, of the water disposed the pore spaces.

There is a need for other ways of obtaining fluid interaction properties of subsurface rock formations and improved values of fluid saturation without the need to retrieve actual formation samples.

### SUMMARY OF THE INVENTION

A method according to one aspect of the invention for determining wettability of rock formations using nuclear magnetic resonance measurements includes determining a relaxation property from the nuclear magnetic resonance measurements of the rock formations. A diffusion property of the rock formations can be determined from the nuclear magnetic resonance measurements. An effective surface relaxivity of the formation can be determined from the relaxation property and the diffusion property. Wettability can be determined from the effective surface relaxivity.

A method according to another aspect for determining wettability of rock formations using nuclear magnetic resonance measurements includes determining a transverse relaxation time of the rock formation from the nuclear magnetic resonance measurements. A longitudinal relaxation time of the rock formation can be determined from the nuclear magnetic resonance measurements. Wettability can be determined by comparing longitudinal relaxation time to the transverse relaxation time.

A method according to another aspect of the invention for determining a surface relaxivity of a subsurface rock formation includes moving a well logging instrument along the interior of a wellbore drilled through rock formations, and making nuclear magnetic resonance measurements of the formations adjacent to the wellbore. A relaxation property can be determined from the nuclear magnetic resonance measurements. A diffusion property of the rock formation can be determined from the nuclear magnetic resonance measurements. The surface relaxivity of the rock formation can be determined from the relaxation property and the diffusion property.

Another aspect of the invention is a method for determining saturation of water and hydrocarbon in a subsurface rock formation using nuclear magnetic resonance (NMR) relaxation time measurements and diffusion constant measurements. The method includes determining relaxation properties of the rock formation from the NMR measurements. Diffusion properties of the rock formation are determined from the NMR measurements. The relaxation properties and the diffusion properties are inverted to determine the saturation of hydrocarbon and water using a model that accounts for restricted diffusion.

Other aspects and advantages of the invention will be apparent from the following description and the appended claims.

### BRIEF DESCRIPTION OF THE DRAWINGS

FIG. 1A shows a wireline NMR instrument deployed in a wellbore.

FIG. 1B shows a logging while drilling NMR instrument deployed in a wellbore.

FIGS. 2A-2B show graphs of NMR relaxation time distribution with respect to grain size and cumulative grain size, respectively for a selected rock formation.

FIG. 2C shows a comparison of uncorrected NMR grain size distribution, corrected NMR grain size distribution, laser determined grain size distribution and sieve determined grain size distribution for the formation shown in FIGS. 2A and 2B.

FIGS. 3A-3B show graphs of NMR relaxation time distribution with respect to grain size and cumulative grain size, respectively for a selected rock formation.

FIG. 3C shows a comparison of uncorrected NMR grain size distribution, corrected NMR grain size distribution, laser determined grain size distribution and sieve determined grain size distribution for the formation shown in FIGS. 3A and 3B.

FIGS. 4A-4B show graphs of NMR relaxation time distribution with respect to grain size and cumulative grain size, respectively for a selected rock formation.

FIG. 4C shows a comparison of uncorrected NMR grain size distribution, corrected NMR grain size distribution, laser determined grain size distribution and sieve determined grain size distribution for the formation shown in FIGS. 4A and 4B.

FIG. 5 shows an example of how the Padé form of D(T₂) in Eq. 7 can be used to fit the surface relaxivity.

FIG. 6 shows examples of T₁-T₂ measurements of three different rock formations with similar pore geometry, but different wettability.

FIG. 7 shows results using a split-180° CPMG measurement sequence on the three formations that were shown in FIG. 6. Out of phase amplitudes are plotted with respect to in-phase signals.

FIG. 8 shows a DT2 map used to determine fluid saturation wherein a restricted diffusion (relaxation time dependent) value is used for the diffusion constant of water.

### DETAILED DESCRIPTION

The present description is in two general parts. The first part includes a description of techniques and apparatus for making nuclear magnetic resonance measurements in a wellbore drilled through subsurface rock formations. The second part includes descriptions of various techniques for interpreting the nuclear magnetic resonance measurements to obtain particular properties of the rock formations.

1. Well Logging Apparatus and Methods.

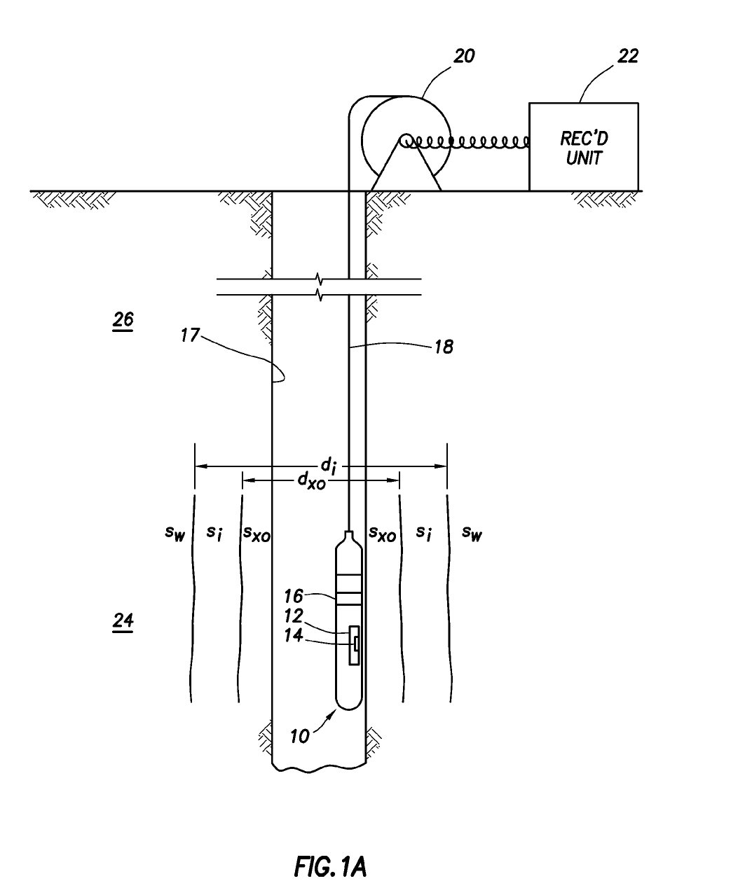

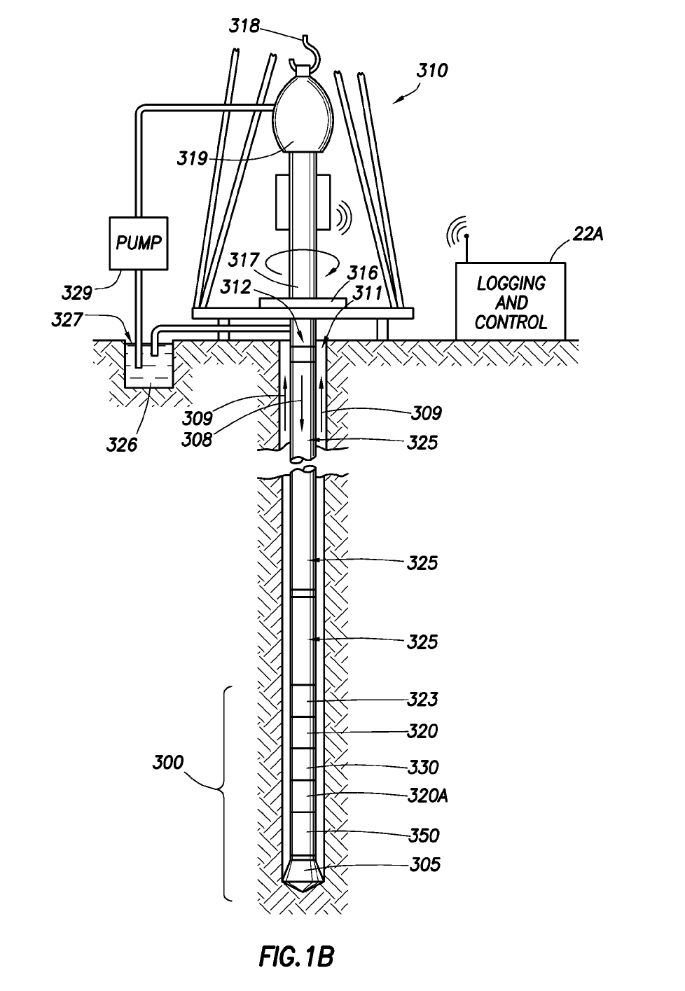

FIG. 1A shows an example nuclear magnetic resonance (“NMR”) wireline well logging instrument 10 disposed in a wellbore 17 drilled through subsurface rock formations 26, 24. The instrument 10 is attached to one end of an armored electrical cable (“wireline”) 18. The cable 18 may be extended into the wellbore 17 and withdrawn therefrom by a spooling device such as a winch 20 of types well known in the art. The cable 18 includes one or more insulated electrical conductors and may include one or more optical fibers to communicate signals between the instrument 10 and a recording unit 22 disposed at the Earth's surface. The recording unit 22 may include a computer (not shown separately) having a screen or printer type data display, input controls and a data recording device for storage of signals (e.g., NMR measurements) communicated from the well logging instrument 10, as well as for storing or displaying calculated results made from NMR measurements made by the instrument 10.

The NMR instrument 10 includes a magnet 12 for inducing a static magnetic field in the formations 24, 26 having a predetermined spatial distribution of magnetic field amplitude. As the instrument 10 is moved along the interior of the wellbore 17, nuclei in the formations surrounding the wellbore are magnetically polarized along the direction of the magnet's 12 field. The instrument 10 also includes an antenna for inducing radio frequency (“RF”) magnetic fields in the formations, and for detecting radio frequency signals induced by NMR phenomena excited in the formations by the static and RF magnetic fields. The particular portion of the formations adjacent to the wellbore from which the NMR signals originate depends on, among other factors, the spatial amplitude distribution of the static magnetic field and the RF frequency used to induce NMR phenomena in the formations. Some magnets may induce a region of substantially homogeneous field amplitude in a particular region in the formations; other types of magnets may induce static fields having a selected amplitude gradient in a particular region of interest. For certain types of measurements, e.g., diffusion, homogeneous field magnets may be supplemented by an electromagnet (not shown) configured to impart a selected magnitude gradient field superimposed on the static homogenous field.

Some formations, for example the one illustrated at 24 in FIG. 1A may be permeable and/or contain movable hydrocarbon in the pore spaces thereof. Proximate the wall of the wellbore 17, a portion of the formation 24 may be subjected to sufficient infiltration of the liquid phase of a fluid (“drilling mud”), called “mud filtrate”, used to drill the wellbore 17, that substantially all of the mobile connate fluids in the pore spaces of the formation 24 are displaced by the mud filtrate. Depending on, for example, the fractional volume of pore space (“porosity”) of the formation 24, and the filtrate characteristics of the drilling mud, the mud filtrate will fully displace all the mobile connate fluids to a depth represented by dₓₒ in FIG. 1A. The foregoing is referred to as the diameter of the “flushed zone.” Partial displacement of connate fluid is shown extending to a diameter represented by dᵢ, which is used to represent the diameter of the “invaded zone.” Ata certain lateral depth in the formation 24, beyond the diameter of the invaded zone, connate fluid is substantially undisturbed. A quantity of interest in determining possible fluid production in from the formation is the fractional volume of the pore space that is occupied by water (and its complement assumed to be occupied by hydrocarbons). In the uninvaded zone, such fractional volume, called “saturation”, is represented by Sw. Invaded zone and flushed zone water saturations are represented, respectively, by Si and Sxo.

The example instrument shown in FIG. 1A is only for purposes of explaining the source of measurements that may be used with a method according to the invention and is not intended to limit the configurations of NMR well logging instrument that may be used to provide measurements for the method of the present invention. Further, reference to portions of formations that contain hydrocarbon are only for purposes of illustrating general principles of NMR well logging; as will be explained below, certain measurements of NMR properties may be made in formations known to be fully water saturated to simplify calculations of formation properties made from the NMR measurements.

FIG. 1B illustrates a well site system in which an NMR well logging instrument can be conveyed using a drill string or other pipe string for measurement during the drilling of the wellbore, or during other pipe string operations associated with the construction of a wellbore such as circulating, washing, reaming and “tripping.” The well site can be onshore or offshore. In the example system of FIG. 1B, a wellbore 311 is drilled through subsurface formations by rotary drilling in a manner that is well known in the art. Other examples of NMR instruments applicable to the present invention can be used in connection with directional drilling apparatus and methods. Accordingly, the configuration shown in FIG. 1B is only intended to illustrate a possible source of NMR measurements and is not intended to limit the scope of the present invention.

A drill string 312 is suspended within the wellbore 311 and includes a bottom hole assembly (“BHA”) 300 proximate the lower end thereof. The BHA 300 includes a drill bit 305 at its lower end. The surface portion of the well site system includes a platform and derrick assembly 310 positioned over the wellbore 311, the assembly 310 including a rotary table 316, kelly 317, hook 318 and rotary swivel 319. The drill string 312 is rotated by the rotary table 316, which is itself operated by well known means not shown in the drawing. The rotary table 316 engages the kelly 317 at the upper end of the drill string 312. The drill string 312 is suspended from the hook 318. The hook 318 is attached to a traveling block (also not shown), through the kelly 317 and the rotary swivel 319 which permits rotation of the drill string 312 relative to the hook 318. As is well known, a top drive system (not shown) could alternatively be used instead of the kelly 317 and rotary table 316 to rotate the drill string 312 from the surface. The drill string 312 may be assembled from a plurality of segments 325 of pipe and/or collars threadedly joined end to end.

In the present example, the surface system further includes drilling fluid (“mud”) 326 stored in a tank or pit 327 formed at the well site. A pump 329 delivers the drilling fluid 326 to the interior of the drill string 312 via a port in the swivel 319, causing the drilling fluid 326 to flow downwardly through the drill string 312 as indicated by the directional arrow 308. The drilling fluid 326 exits the drill string 312 via water courses, or nozzles (“jets”) in the drill bit 305, and then circulates upwardly through the annulus region between the outside of the drill string and the wall of the borehole, as indicated by the directional arrows 309. In this well known manner, the drilling fluid 326 lubricates the drill bit 305 and carries formation cuttings up to the surface, whereupon the drilling fluid 326 is cleaned and returned to the pit 327 for recirculation.

The bottom hole assembly 300 of the illustrated example can include a logging-while-drilling LWD) module 320, a measuring-while-drilling (MWD) module 330, a steerable directional drilling system such as a rotary steerable system and/or an hydraulically operated motor such as a steerable motor, and the drill bit 305.

The LWD module 320 is housed in a special type of drill collar, as is known in the art, and can contain one or a plurality of known types of well logging instruments. It will also be understood that more than one LWD and/or MWD module can be used, e.g. as represented at 320A. (References, throughout, to a module at the position of LWD module 320 can alternatively mean a module at the position of MWD module 320A as well.) The LWD module 320A typically includes capabilities for measuring, processing, and storing information, as well as for communicating with the surface equipment. In the present embodiment, the LWD module 320 includes an NMR measuring instrument. An example configuration of such instrument is explained above with reference to FIG. 1A.

The MWD module 330 is also housed in a special type of drill collar, as is known in the art, and can contain one or more devices for measuring characteristics of the drill string and drill bit. The MWD module 330 further includes an apparatus (not shown) for generating electrical power for the downhole portion of the well site system. Such apparatus typically includes a turbine generator powered by the flow of the drilling fluid 326, it being understood that other power and/or battery systems may be used while remaining within the scope of the present invention. In the present example, the MWD 330 module can include one or more of the following types of measuring devices: a weight-on-bit measuring device, a torque measuring device, a vibration measuring device, a shock measuring device, a stick slip measuring device, a direction measuring device, and an inclination measuring device.

The foregoing examples of wireline and drill string conveyance of a well logging instrument are not to be construed as a limitation on the types of conveyance that may be used for the well logging instrument. Any other conveyance known in the art may be used, including without limitation, slickline (solid wire cable), coiled tubing, well tractor and production tubing.

A recording unit 22A may be disposed at the surface and may include data acquisition, recording, input, control and display devices similar to those of the recording unit shown at 22 in FIG. 1A.

In example methods according to the invention, measurements of nuclear magnetic resonance (“NMR”) properties of subsurface formations may be made at one or . more lateral depths into the formations adjacent to the wellbore. A NMR instrument, as explained above with reference to FIGS. 1A and 1B, can be moved along a wellbore drilled through subsurface formations. As explained with reference to FIG. 1A, NMR measurement made by the instrument includes prepolarizing nuclei in the formations by imparting a static magnetic field in the formations. The static magnetic field has known spatial amplitude distribution and known spatial gradient distribution. NMR phenomena are excited in the formations by applying a radio frequency (“RF”) magnetic field to the prepolarized nuclei. A frequency of the RF magnetic field is selected to excite NMR phenomena in selected types of nuclei and within particular volumes in the formations (“sensitive volumes”). As is known in the art, the spatial position of the sensitive volume depends on the spatial distribution of the amplitude of the static magnetic field, the gyromagnetic ratio of the selected nuclei and the frequency of the RF magnetic field. Electromagnetic fields resulting from the induced NMR phenomena are detected and analyzed to determine NMR properties of the formations within the sensitive volumes. Such properties may include distribution of longitudinal and transverse relaxation times and distributions thereof (T₁ and T₂, respectively), diffusion constants (D) and joint distribution functions of relaxation time and diffusion coefficient etc., of the various components of the formations. The foregoing parameters may be used to estimate, as non limiting examples, the total fractional volume of pore space (“total porosity”) of the various subsurface formations, the bulk volume of “bound” water (water that is chemically or otherwise bound to the formation rock grains, such as by capillary pressure, and is therefore immobile), the fractional volume of the pore space occupied by movable water (“free water”) and the fractional volume of the pore space occupied by oil and/or gas. As will be further explained below, the same NMR parameters may be used according to the present invention to determine certain other properties of subsurface rock formations

In one example, NMR measurements may be made using an instrument identified by the trademark MR SCANNER, which is a trademark of the assignee the present invention. In another example, the NMR measurements may be made using an instrument identified by the trademark CMR, which is also a trademark of the assignee of the present invention. The NMR instrument, irrespective of type, is generally moved longitudinally along the wellbore and a record with respect to depth in the wellbore is made of the NMR properties of the various formations. The foregoing identified MR SCANNER instrument, in particular, can make measurements of NMR properties of the formations at a plurality of different, defined lateral depths of investigation. The lateral depths of investigation for the foregoing instrument are about 1.5 inches (3.8 cm), 2.7 inches (6.9 cm) and 4 inches (10.2 cm) from the wall of the wellbore. As explained above, the lateral depth of investigation of any particular NMR measurement is defined by the spatial distribution of the amplitude of the static magnetic field and the frequency of the RF magnetic field used to excite NMR phenomena. The example instruments described herein are not limitations on the scope of this invention but are provided only to illustrate the principle of the invention.

2. Methods for Obtaining Formation Properties from NMR Measurements

In general, in example methods according to the invention, NMR relaxometry measurements are made of the formation in order to determine, with respect to time, transverse spin echo amplitudes of the formation from initial transverse reorientation of the magnetic spins of susceptible nuclei in the formation (typically hydrogen associated with water) or longitudinal inversion recovery. It is generally understood that the rate of decay of spin echo amplitudes is a multiexponential function related to the quantity of and specific (intrinsic) relaxation time of various materials in the rock formation. The decay of spin echo amplitudes is also related to interactions between the fluid and solid rock grains.

Interactions of the fluid with the solid rock grains (matrix) are characterized by the surface relaxivity parameter, p, which determines how much the signal from the measured resonant nuclei will relax (or diminish) due to the interaction. Most models relating NMR signal to pore structure refer to p, whether explicitly or implicitly. In petrophysical applications, one typically measures a distribution of surface relaxation times (T_{1S} or T_{2S}) which is then related to the distribution of pore sizes with the use of the simple formula T_{1S} (or T_{2S})=R/p, where R is the size of the pore and T_{1S} (or T_{2S}) is the relaxation time. Knowledge of pore size distributions is important in materials quality control, in estimates of capillary pressure curves, and in determination of fluid distribution and saturation profiles as well as flow properties. For example, formulas for NMR rock permeability all derive from a pore size distribution and thus scale with p. Reservoir rock permeability determines how easily hydrocarbon will flow through the medium and thus is of obvious significance to the oil industry. Similarly, p determines the sensitivity of the NMR measurement to the wettability of the reservoir rock, which, again, is an important parameter in reservoir modeling. Furthermore, the measurement of p in partially oil saturated rocks will contain information about the distribution of oil and water within the pore space, as relaxation on the oil-water interfaces as well as oil-rock interfaces will be different than on the water-rock interfaces. The distribution of fluids inside the pore space is related to the capillary pressure curves within the particular rock formation. Finally, for oil-water mixtures, such as emulsions or systems with two-phases, the measurement of p can be be indicative of the presence of free radicals and paramagnetic atoms at the water-oil interface, which could originate from asphaltenes collecting at the interfaces due to their polar nature. Measurement of p determined from NMR measurements may enable several improved techniques for determining formation properties. Examples of such improved techniques include the following, each of which will be described in greater detail in the present description.

Improved Water—Oil Saturation

An accurate value of peff allows one to predict accurately where the brine contributions will fall on a D-T2 map. This is a clear improvement over the method currently known in the art that ignores restricted diffusion and assumes that the measured diffusion coefficient of water is given by its molecular diffusion coefficient at the appropriate reservoir condition. Correcting for the effect of restricted diffusion may improve the calculation of water saturation from D-T2 maps.

Wettability Indicator in Partially Saturated Rock

In partially saturated rocks, the diffusion of brine molecules is restricted by both brine—grain (Sw-gr) and brine—hydrocarbon (Sw-oil) interfaces. However, the relaxation will be dominated by the brine—grain interfaces only. For this reason, the extracted value of peff in partially saturated rocks will be reduced from the value of peff of fully brine saturated rocks by the factor Sw-gr/(Sw-gr+Sw-oil). By comparing the extracted surface relaxivity at different saturations, it is possible to estimate the ratio of brine-grain surface area to brine-hydrocarbon surface area. This ratio is large (>>1) for water-wet pore space systems and small (<<1) for oil-wet pore space systems. Therefore, this ratio can be used to as an indicator of wettability.

Wettability Indicator in the Flushed Zone

NMR well logging using instruments known in the art is only able to obtain measurements of the reservoir and other rock formations at relatively shallow depths of investigation (DOI). At these shallow DOI, the formations are often invaded by the liquid phase of the drilling fluid (mud filtrate) and the movable hydrocarbons are often flushed (removed from the pore spaces) by such invasion. When NMR logging is used to assess the wettability of the formation, it is advantageous to use water based drilling fluids (muds) rather than oil based muds that typically contain surfactants that might modify the surfaces. Even if all the hydrocarbons have been flushed away at the NMR DOI, it is believed to be possible to probe changes in wettability by NMR techniques because changes in wettability are expected to be reflected by changes in surface relaxivity. Therefore, a record with respect to depth (log) of peff in the flushed zone, determined as will be explained using NMR measurements, can be used to infer wettability changes in the formations.

Pore Size Calibration.

Assuming that the surface relaxivity is roughly constant in a particular well, one can use the measured value of peff to convert distribution of measured relaxation times in the wetting phase to distribution of pore size. Having a calibrated pore size will improve estimate capillary pressure curves and of flow parameters, including permeability.

One possible way to obtain pore size distribution (PSD) of formation comprised, for example, of sand particles, from NMR measurements will now be explained. In a fully water saturated porous rock formation, NMR transverse relaxation time (T₂) measurements are related to the pore size of the rock formation through the surface relaxivity (p₂). The pore size of the rock is also related to the grain size of the rock. For uniform size rock grain particles and uniform packing of the grains, this relationship is given by the expression:

$$\frac{1}{{ρ}_{2} {T}_{2}} = \frac{S}{V} = \frac{3 ( 1 - φ )}{φ {r}_{g}} \qquad ( Eq . 1 )$$

where p₂ represents the surface relaxivity (in units of length per unit time LT⁻¹), T₂ represents the NMR transverse relaxation time (in units of time T), S represents the surface area (L²), V represents the total pore volume (L³) φ represents the porosity (the fractional volume of rock pore spaces with respect to total rock volume) and r_{g} represents the rock grain radius (in units of length L).

While the present example, and additional examples to be explained below, use the transverse magnetic relaxation time (T₂), it should be clearly understood that techniques are known in the art for using NMR measurements to determine longitudinal relaxation time (T₁), and relationships are known in the art that relate T₁ to T₂ given the knowledge of certain rock formation and pore fluid parameters. Accordingly, the invention is not limited in scope to using T₂ measurements. In fact, the entire methodology outlined below carries over to T₁ measurements with the simple replacement of the subscript 2 with l in all the T₂'s and p₂'s, where p₁ is the longitudinal surface relaxivity, just as p₂ represents the transverse surface relaxivity. Both T₁ and T₂ contain similar information as far as this invention is concerned (even in combination with diffusion as discussed below for the case of T₂) and both can be used to extract grain size distributions as described for the T₂ case below.

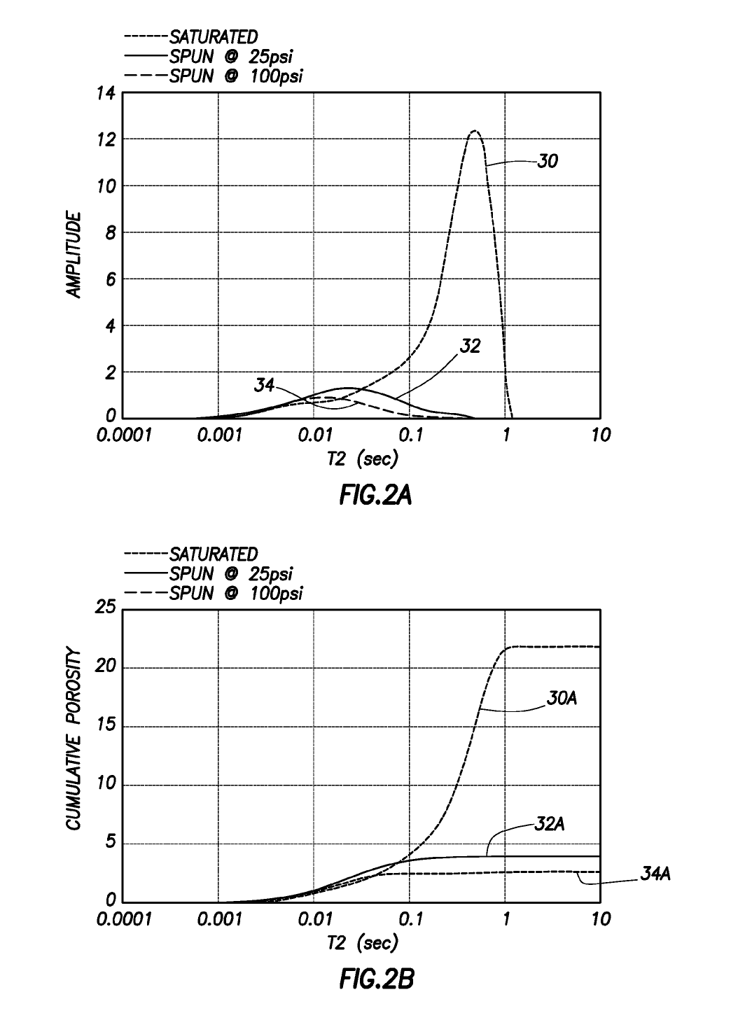

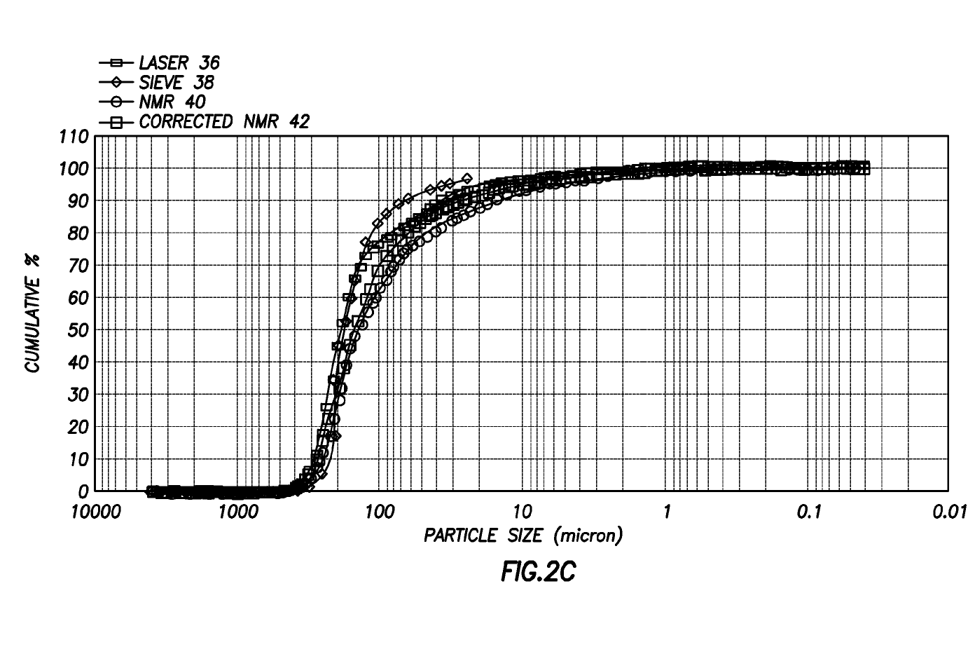

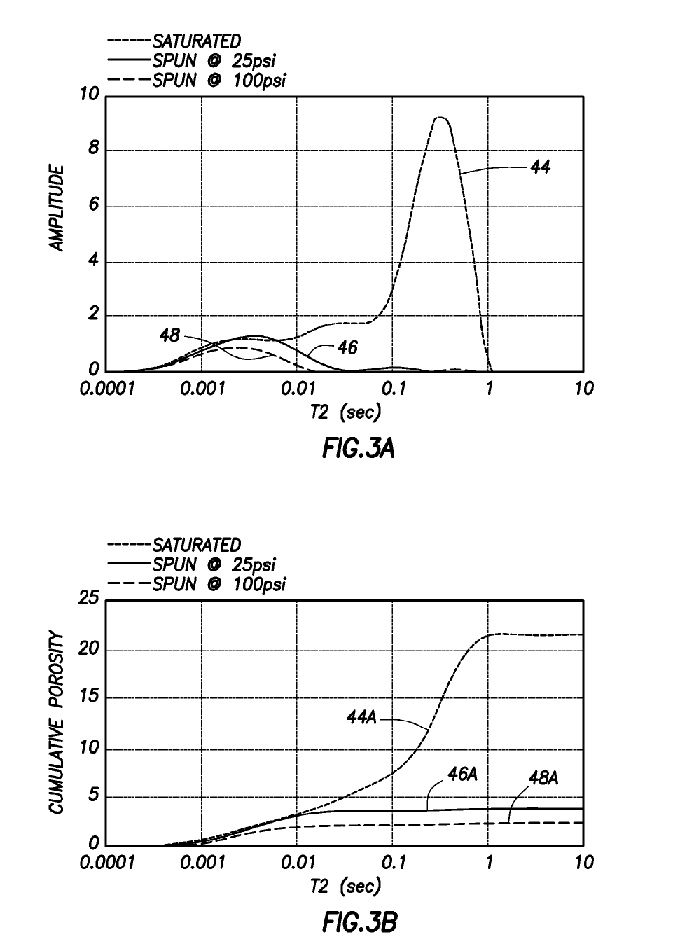

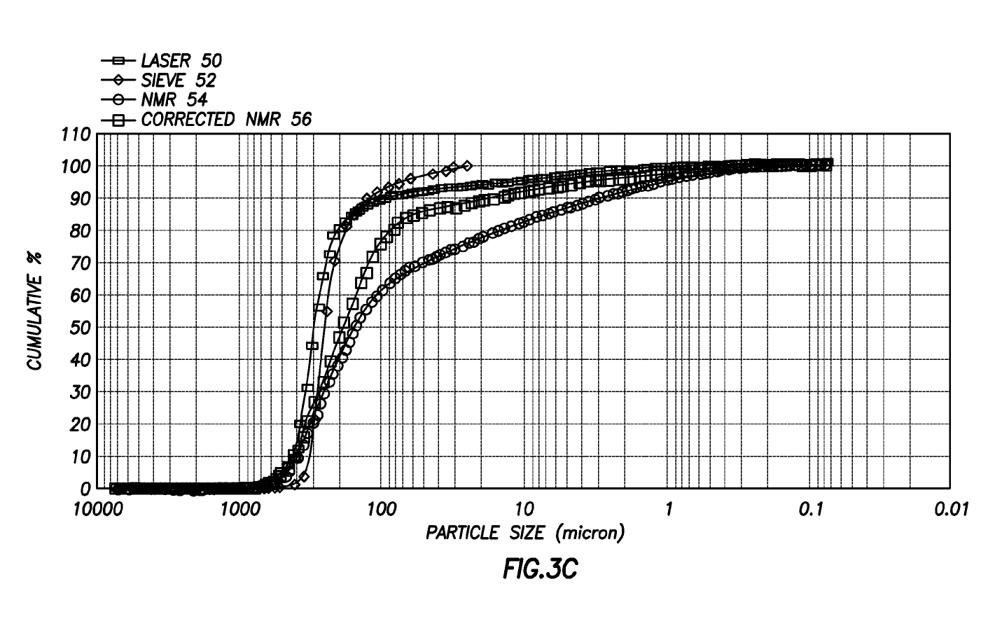

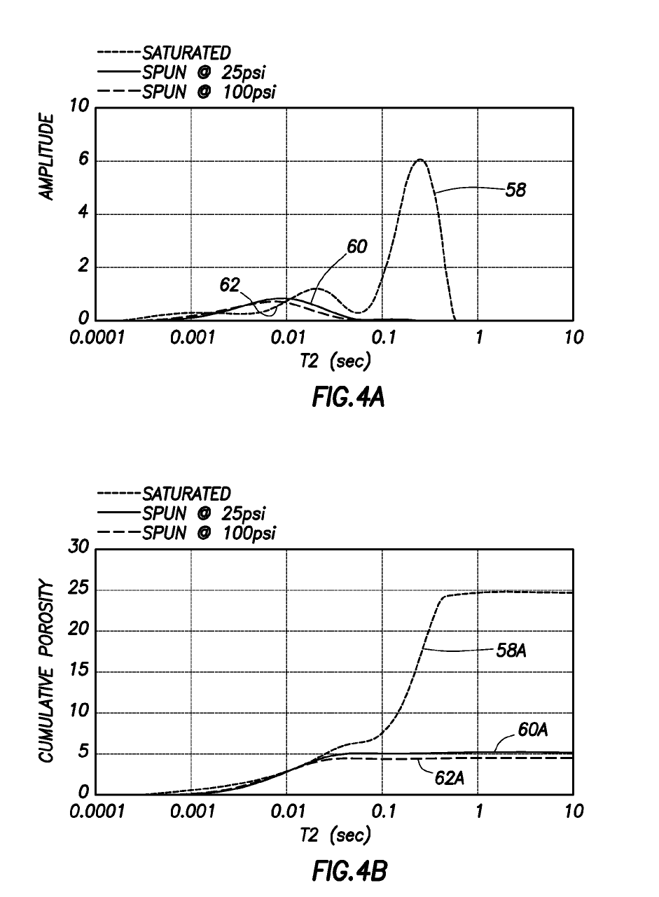

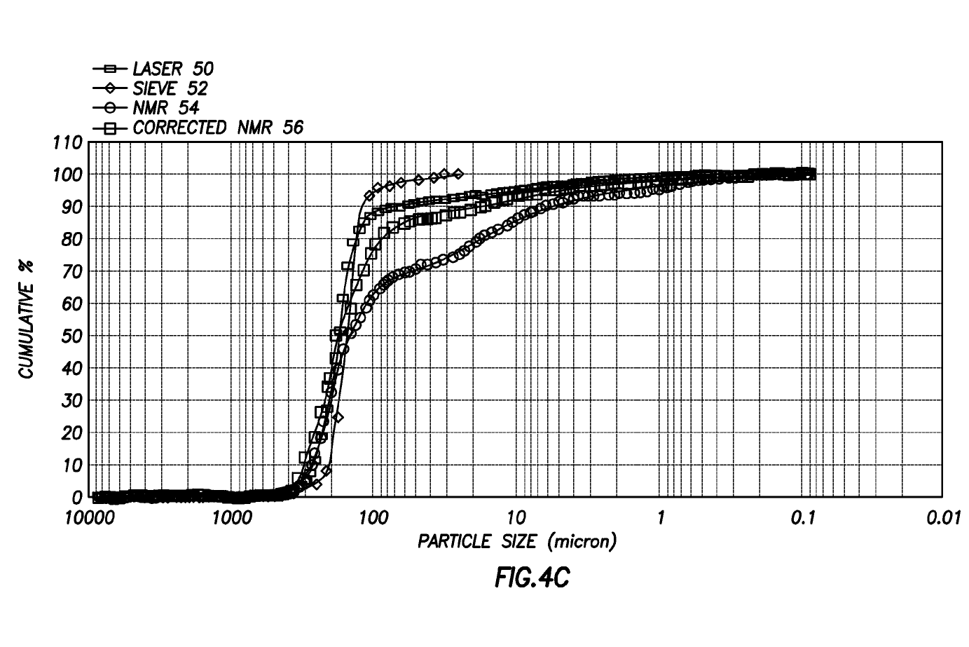

In one example, a core sample, e.g., a whole drilled core, of particular subsurface rock formation may have the foregoing NMR T₂ measurements obtained. The PSD may be determined, for example, from sieve analysis or laser analysis. It is then possible to back calculate the surface relaxivity p₂ such that PSD predicted from NMR measurements matches the PSD obtained from laser analysis or sieve analysis. The foregoing procedure was performed for seven different rock formation cores, and the results for three of the cores relevant to this description are shown in FIGS. 2A-2C for Berea sandstone, FIGS. 3A-3C for Briar Hill formation, and FIGS. 4A-4C for Castlegate formation. In FIG. 2A the transverse relaxation time (T₂) distribution is shown for water saturated rock at curve 30, for rock spun at 25 psi at curve 32 and spun at 100 psi at curve 34. Corresponding curves are shown in FIG. 2B at 30A, 32A, 34A. FIG. 2C shows curves for cumulative particle size distribution for PDS determined by laser, curve 36, sieve, curve 38, NMR uncorrected for surface relaxivity at curve 40 and NMR corrected for surface relaxivity at curve 42. Corresponding curves to those of FIG. 2A are shown at 44, 46 and 48 in FIG. 3A, at 44A, 46A, and 48A in FIG. 3B and at 50, 52, 54, 56 in FIG. 3C, respectively. Similarly, corresponding curves to those in FIG. 2A are shown in FIG. 4A at 58, 60 and 62, and in FIG. 4B at 58A, 60A, 62A, respectively. Corresponding curves to those in FIG. 2C are shown in FIG. 4C at 64, 66, 68 and 70, respectively.

As described above with reference to Eq. (1), the NMR T₂ is proportional to the surface-to-volume ratio (SVR) of the pore system. The SVR is further related to the grain size and the porosity, e.g., Eq. 1 for spherical rock grains. To account for non-spherical rock grains, a parameter A can be introduced to modify equation 1:

$${r}_{g} = A \frac{3 ( 1 - φ ) {ρ}_{2} {T}_{2}}{φ} \qquad ( Eq . 2 )$$

A=1 for spherical grains, and r_{g} may be considered as some average of the grain dimensions (e.g., average of the long and short axis lengths). In practice, p₂=Ap₂ may be used as an effective surface relaxivity parameter to be calibrated by experiment (e.g., laser or sieve measurements on rock samples).

For a rock formation that constitutes a packing of substantially single size grains, for example, a loose pack of glass beads, Fontainbleu sandstone, Bentheimer sandstone, the NMR T₂ distributions tend to show a narrow peak indicating the narrow range of pore sizes, and correspondingly, a narrow range of rock grain size. The T₂ distribution can be integrated to obtain the cumulative pore size distribution. Using equation 2, the T₂ (coordinate) axis of a graph of relaxation time with respect to frequency of occurrence or cumulative occurrence of can be converted to grain diameter (or radius) to plot the NMR derived PSD. The NMR derived PSD thus determined can be directly compared with the PSD obtained from laser and sieve measurements. Using the comparison of the NMR results and PSD (from laser or sieve analysis), the parameter p₂ can be empirically determined for particular formations.

For a rock formation with a mixture of different grain sizes, there are two different sets of conditions to consider in analysis of PSD using NMR measurements. The first set of conditions is that the different sized grains are spatially separated within different parts of the sample, such as may result from different deposition beddings. In such case, large grains will form larger pores and longer T₂, while the smaller grains will form smaller pores in separate parts of the formation. The T₂ distribution will still directly provide the grain size distributions (depending on determination of surface relaxivity as explained above).

In the second set of conditions, smaller grains may be disposed within the large pores formed by the larger grains. In such cases typically the smaller grains are much smaller than the larger ones, e.g., at least an order of magnitude difference in grain size. The small grains will form small pores with pore size and T₂ related their grain size (as may be represented by Eq. (1) or (2). Furthermore, because the small grains and corresponding pores occupy the pore space created by the large grains, the measured porosity within the large pores will be reduced. As a result, the T₂ distribution will show less signal from the large pores. In order to obtain the true grain volume of the large grains in such cases, the following procedure can be used.

In such rocks with a large range of pore sizes and sand grain sizes, T₂ distribution is often very broad with large pores at long T₂ and small pores at short T₂. Let the small pore volume be represented by Vₛₚ, so that the total volume of the aggregates of the small grains will be Vₛₚ/φ, where φ is the porosity. The foregoing volume is assumed to be the missing pore volume that is originally created by the large grains. Therefore, the presence of the small pores contributes to an additional grain volume of the larger grains by a factor Vₛₚ(1−φ)/φ².

An example procedure to obtain a corrected grain size distribution is the following: First, obtain NMR T₂ distribution by measurements made in the particular rock formation. Next, identify the large pores and correspondingly the large grains from the T₂ distribution. Frequently, this value is the peak amplitude at large values of T₂. Then assign a cut-off value, T_{2c}. For T₂>T_{2c}, the values of T₂ are assigned to large grains; when T₂<T_{2c}, the relaxation time is assigned to small grains. Then, integrate the T₂ distribution for the smaller grains (pores) to obtain the small grain/pore porosity φₛₚ. Then integrate the T₂ distribution for the large grains (pores) to obtain the large grain/pore porosity φₗₚ. Finally, calculate the value φₛₚ/(φφₗₚ)+1.

Multiply the foregoing value by the large pore part of the T₂ distribution (above the cutoff) to obtain a corrected large pore T₂ distribution. This corrected T₂ distribution contains both the short T₂ part and the long T₂ part. The corrected T₂ distribution may then be used as explained above to obtain the PSD.

The foregoing method using corrected NMR T₂ distribution will enhance the distribution determination for the larger grains and reduce the relative amount the smaller grains. For a rock formation having partial grain size mixing, i.e., some small grains are inside the large pores and some other smaller grains are spatially separated from the large grains, the true PSD will typically be between the two NMR derived PSDs as explained above (i.e., the uncorrected T₂ distribution method of Eq. (2) and the corrected method described above).

As mentioned above, having the capability of producing a log (a record with respect to depth in the wellbore) of effective relaxivity is useful for a number of purposes. It has been determined that it is possible to obtain values of the surface relaxivity for certain rock formations using both the transverse relaxation time distribution and the diffusion constant measured in a wellbore using a suitable NMR well logging instrument. In a water-saturated sand pack (or any other porous medium), diffusing water molecules undergo frequent collisions with the grain surfaces. This leads to the effect of restricted diffusion, whereby the mean squared displacement of the NMR-active molecules (referred to as the spins) is reduced from the Einstein relationship for bulk diffusion:

[symbol]

|F(T_{d})−F(0)|² [symbol] _{unrestricted}=6D₀T_{d} (Eq. 3)

where T_{d} is the time during which the diffusion takes place. It is well-known that this effect can be described by a time-dependent diffusion coefficient D(T_{d}) that is reduced from the molecular diffusion coefficient D₀. This reduction increases with the diffusion time T_{d}. At short times, the reduction only depends on the local surface-to-volume ratio of the pore, S/Vₚ:

$$\frac{D ( {T}_{d} )}{{D}_{0}} = 1 - \frac{4 \sqrt{{D}_{o} {T}_{d}}}{9 \sqrt{π}} \frac{S}{{V}_{p}} \qquad ( Eq . 4 )$$

At the same time, wall collisions induce surface relaxation of the total magnetization which has been found to be typically given by exponential decay with a relaxation rate:

$$\frac{1}{{T}_{2 , s}} = {ρ}_{2} \frac{S}{{V}_{p}} \qquad ( Eq . 5 )$$

In which T_{2.s} represents the surface transverse relaxation time. The proportionality factor p₂ is the surface relaxivity. Combining Eqs. (4) and (5), one obtains for the short-time, or equivalently, the large-pore regime:

$$\frac{D ( {T}_{2} )}{{D}_{0}} = 1 - \frac{4 \sqrt{{D}_{0} {T}_{d}}}{9 \sqrt{π}} \frac{1}{{ρ}_{2}} \frac{1}{{T}_{2 , s}} \qquad ( Eq . 6 )$$

Thus, with a measurement of D(T₂), it is then possible to determine the surface relaxivity of the rock formation. If the short-time/large-pore regime cannot be reached due to experimental constraints (for example, if all the pores are too small or the available magnetic field gradients are too weak), it may still be possible to fit p₂ from a model form of D(T₂) obtained by the Padé approximation interpolation between the short-time/large-pore formula in Eq. (6) and a constant tortuosity value of D(T₂)=D_{∞} which holds for long-times/small pores as described in, P. N. Sen., Time-dependent diffusion coefficient as a probe of geometry, Concepts in Magnetic Resonance, 23A:1, (2004). The interpolated formula is:

$$D ( {T}_{2} ) - {D}_{0} [ 1 - γ \frac{α {L}_{D} + {( {L}_{D} / {L}_{M} )}^{2}}{α {L}_{D} + {( {L}_{D} / {L}_{M} )}^{2} + {γ}^{2}} ] \qquad ( Eq . 7 )$$

where

$$α = \frac{4}{9 \sqrt{π}} \frac{1}{{ρ}_{2} {T}_{2 , s}} ,$$

L_{D}=\sqrt{D₀T_{d}}, wherein T_{d} is the diffusion time,

$$γ = 1 - \frac{{D}_{∞}}{{D}_{0}} ,$$

and L_{M} is a heterogeneity length scale of the medium, which is typically much greater than the diffusion length L_{D}.

Note that D₀ is the diffusion constant of the bulk fluid, which is a property of the fluid by itself and can be determined from laboratory measurements. It is also possible to obtain well-defined tables for the diffusion coefficient of the given fluid as a function of temperature, as is the case for water and simple oils. D_{∞} is a property of the fluid as well the rock and can be approximated as:

D_{∞}=D₀φ^{m-1} (Eq. 8)

where φ represents the rock porosity (fractional volume of pore space in a known rock volume) and m is the cementation exponent that appears in the well-known Archie water saturation equation. Then γ in Eq. (7) can be written as γ=1−φ^{m-1}. Thus, by knowing D₀ for the given fluid and m for the given rock, D(T₂) can be determined for different values of p₂ using the Padé interpolation given by Eq. (7).

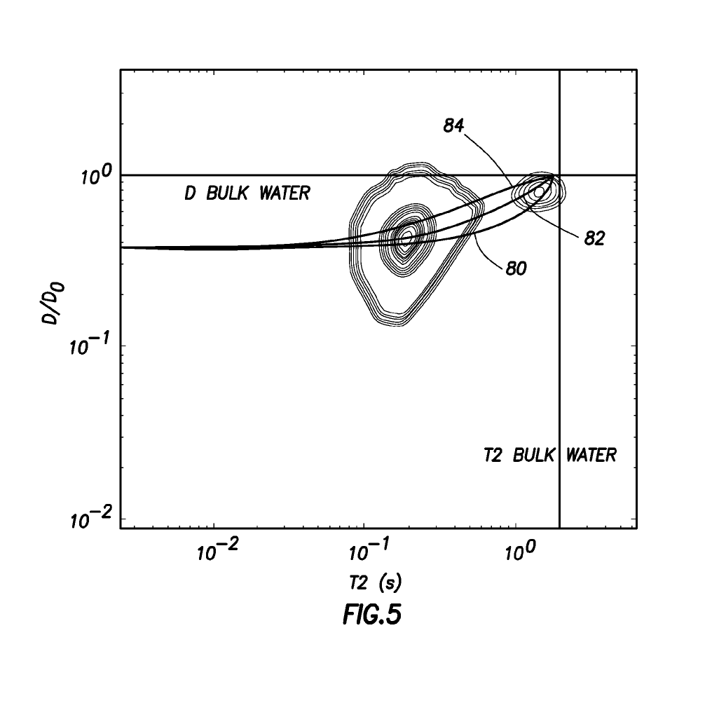

FIG. 5 shows an example of how the Padé form of D(T₂) in Eq. (7) can be used to fit the surface relaxivity. The contour plot shows a diffusion-relaxation (D-T2) map, which is a standard computed (answer) product delivered by oil services providers such as Schlumberger Technology Corp. using their NMR logging instrument (e.g., one operated under the service mark MR SCANNER, which is a mark of the assignee of the present invention). The D-T2 map is obtained by first encoding diffusion using either pulsed field gradients or constant magnetic field gradients via a spin echo or stimulated spin echo experiment, both of which are standard NMR pulse sequences, followed by a CPMG (Carr-Purcell-Meiboom-Gill) pulse sequence (also a standard NMR pulse sequence) to encode relaxation. The data acquired in this fashion are then inverted via a two-dimensional inverse Laplace transform to generate the D-T2 map. The whole technique of acquiring such two-dimensional NMR methods is well documented and published in scientific literature. See, for example, Song et al., J Magn. Reson. 154, 261-268 (2002); Hurlimann et al., J. Magn. Reson. 157, 31-42 (2002), U.S. Pat. Nos. 6,462,542 and 6,570,382. Similarly, one can acquire and process DT1 data, not shown here but also documented in the literature. The analysis for obtaining p₁ will be analogous to that for p₂ described in the following, except using a D-Tl map in place of D-T2. The curve that best matches the distribution, i.e., appears to go through the peak 82, in this example overplotted on the D-T2 map corresponds to p₂=2.5 μm/s. Other criteria can be used to determine the best match to the distribution, such as a least-squares fit of the Padé curve to the mean or log-mean of the diffusion dimension of the distribution as a function of T₂. As will be further explained below, Eq. (7) and the values of surface relaxivity determined as explained above may be used to determine more accurate values of fluid saturation than is possible using techniques known in the art.

In another aspect, the invention relates to determining wettability of the rock formation from NMR measurements. Two such techniques will be explained herein. In the first technique described herein two NMR measurements are combined that both depend on the geometrical configurations of fluids filling the pore space of a rock. The two measurements are relaxation and diffusion.

When a rock formation is saturated with a mixture of water and oil, the relationship given in Eq. (7) may be modified. In the case when the grain surfaces are mixed oil and water wet, it may be assumed that each part of the grain surface can be classified as either preferentially water wet or preferentially oil wet. When the rock is saturated with oil and water, the water molecules will only make direct contact with the grain surfaces at the fraction of the grain surface that is water wet and vice versa for oil. In this case, the diffusing water fluid molecules encounter two different types of surfaces: Sg, w denotes the surface are of contact between water and the rock grains, and So, w denotes the surface area of the oil-water interfaces. The total surface area for the water phase is thus Sw=Sg, w+So, w. Similarly, for the oil phase the total surface area is So=Sg, o+So, w in which Sg, o represents the surface area of the rock grains wetted with oil. The pore volumes filled with water or oil are denoted Vw and Vo, respectively. Both types of wetted rock grain surfaces impede the diffusion of nuclear magnetic spins and therefore, the relevant ratio of surface to volume for water is Sw/Vw. However, the two types of surfaces, oil wet and water wet, have different relaxation properties. Ordinarily, relaxation at the oil-water interfaces can be neglected compared to relaxation at the grain-fluid interfaces. Using such assumption, the relevant ratio is Sg, w/Vw. As a consequence, the relationship between the measured diffusion coefficient and the relaxation rate in Eq. (6) requires an additional factor of (Sg, w+So, w)/Sg, w in the second term. Alternatively, one may replace in Eq. (6) the intrinsic surface relaxivity, p₂ or p₁ by an effective reduced surface relaxivity p_{eff}.

$${ρ}_{eff} = \frac{{S}_{g , w}}{{S}_{g , w} + {S}_{o , w}} ρ \qquad ( Eq . 9 )$$

wherein the relaxivity in the last term of Eq. (9) is either the transverse or longitudinal intrinsic relaxivity. The effective relaxivity given in Eq. (9) is reduced from the intrinsic relaxivity because only a fraction of the surfaces are undergoing relaxation. This implies that with partial oil/water saturation and mixed wettability, the initial slope of the relationship between the measured diffusion coefficient and the measured relaxation rate is increased as compared to measurements in fully water saturated, water-wet rock formations. Spins with the same relaxation time will be in general more restricted in partially saturated systems than in fully water saturated systems.

An analogous relationship can be written for the oil phase. In this case, Do will be the molecular diffusion coefficient of bulk oil and p may be interpreted as the surface relaxivity of oil on the oil wet surfaces. The relationship for oil is more difficult to apply, because diffusion and bulk relaxation rates for the oil have to be described by distributions. A comparison of Eq. (7) and (9) shows that by comparing measurements performed in fully water saturated, water wet rocks and in partially saturated rocks, a geometrical ratio λ can be determined as defined by the following expression:

$$λ = \frac{{S}_{g , w}}{{S}_{g , w} + {S}_{o , w}} \qquad ( Eq . 10 )$$

The ratio in Eq. (10) depends on the geometry of the pore spaces and the configuration of the oil and water phases. To infer wettability, it is useful to determine the ratio Sg, o/Sg, w. Such ratio may be used to infer wettability in the following manner:

λ<<1: water—wet formation

λ≈1: mixed—wet formation

λ>>1: oil—wet formation

In general, one has to make some assumptions to relate the measured ratio λ to the desired ratio the ratio Sg, o/Sg, w. However, there are two simple limiting cases: (1) after nearly complete drainage when Vo>>Vw , the remaining water will cover the water-wet surfaces of the grains. In this case, So,w≈Sg, w and λ≈½, i.e., the effective surface relaxivity will be reduced from the intrinsic relaxivity p by a factor of about 2; and (2) after imbibition, Vw>>Vo. In such case, oil-wet patches of the grains will remain covered by a film of oil. In this case, So,w≈Sg,o, and λ can be determined as follows:

$$λ \approx \frac{{S}_{g , w}}{{S}_{g , w} + {S}_{o , w}} = \frac{1}{1 + \frac{{S}_{g , o}}{{S}_{g , w}}} \qquad ( Eq . 11 )$$

The second case is the relevant case when the well is drilled with water based mud and the flushed zone (see Sₓₒ in FIG. 1) is investigated with the NMR instrument. In this case, the change in slope in the D−T_{2,s}⁻¹; measurements is given by the expression:

$$\begin{matrix}\frac{ρ}{{ρ}_{eff}} = 1 + \frac{{S}_{g , o}}{{S}_{g , w}} & ( Eq . 12 a ) \\ lw = 2 \times \frac{{ρ}_{eff}}{ρ} - 1 & ( Eq . 12 b )\end{matrix}$$

Eq. (12a) can then be used to infer wettability in the flushed zone by analyzing diffusion editing measurements, and Eq. (12b) can be used to define a wettability index, lw. The extracted values of p_{eff} are compared with the value of p measured either in a water zone that is known to be water wet, or with a calibration sample measured on the surface. The wettability extracted by this method is the wettability of the large pores. If no reference measurement for p is available, then the continuous measurement of p_{eff} can still be used to infer trends in wettability. Unlike other methods proposed for the determination of wettability, the foregoing method does not require that the pore size distribution is constant between different samples. In addition, as a result of the fact that the measurement is performed in the flushed zone where the oil saturation is low, it does not require the separation of the oil signal from the water signal.

Some known limitations of this technique may include the following.

(1) the well must be drilled with water based mud systems. If oil based muds are used, any surfactants will likely modify wettability in flushed zone;

(2) the formation must have some sufficiently large pores so that the short time approximation in Eq. (4) applies This implies that there should be at least some pores of size 7 micrometers or larger. The absence of such sized pore is evident from the data and will not lead to misinterpretation;

(3) the intrinsic surface relaxation properties (i.e. p) of the water wet surfaces have to be reasonably uniform and not change abruptly between different formation layers; and

(4) in some cases, the irreducible oil saturation in the flushed zone can be substantial. This immovable hydrocarbon might not all be trapped in thin films next to oil-wet surfaces. As an example, in completely water wet formations, a finite amount of oil is generally trapped during imbibition. This will increase So, w compared to Sg, o. However, it is expected that in most cases, this extra surface area will not be too large since surface tension minimizes the oil-water interfaces, whereas the grain-water interfaces do not have this constraint.

Wettability is determined by the surface properties of the rock grains and the interactions with the fluids. Surface relaxation is also affected by these factors. In another example method for obtaining wettability from NMR measurements it is proposed to take advantage of these facts and measure an aspect of surface relaxation in brine saturated rocks that is sensitive to wettability. Note that in this implementation, wettability information can be obtained from measurements on rocks that are fully brine saturated. It is not necessary to have both hydrocarbon and water present. It is therefore well suited for measurements in the flushed zone (defined above). The present example method still works when there is hydrocarbon present, as long as the water NMR signal can be distinguished from the hydrocarbon NMR signal. This can be performed, for example, with standard diffusion-relaxation measurements.

Measured NMR relaxation rates depend on the details of the experimental set-up. The relaxation rates for the transverse and longitudinal magnetization generally differ. The measured rates also depend on the Larmor frequency of the measurement. T₁ relaxation rates generally increase at lower magnetic field amplitudes (and thus lower Larmor frequencies). This can be analyzed in terms of the spectral density J(ω) of the underlying relaxation process. In the simplest case for relaxation induced by dipole—dipole interaction, the relationship between the relaxation rates and the spectral density function is given by the expression T₂⁻¹ is proportional to 3J(0)+5J(ωL)+2J(2ωL) for transverse relaxation, and T₁⁻¹ is proportional to 2J(ωL)+8J(2ωL) for longitudinal relaxation. In the foregoing expressions, ωL is the Larmor frequency. If the spectral density function is independent of frequency for frequencies less than 2ωL, then T₁=T₂. However, in brine saturated rocks, one finds that the T₁/T₂ ratio is consistently larger than 1, typically in the range between 1 and 2. This indicates that the process responsible for NMR relaxation contains some slow motion, leading to the increase of the T₁/T₂ ratio. Such slow motions can be a sign of surface diffusion or exchange processes. Wettability is strongly affected by such effects. Therefore it is proposed to monitor the presence of such slow processes as a wettability indicator. It will allow detecting changes in wettability. To relate the measurements to an absolute wettability (i.e. directly relate it to the Amott index), calibration experiments would be required.

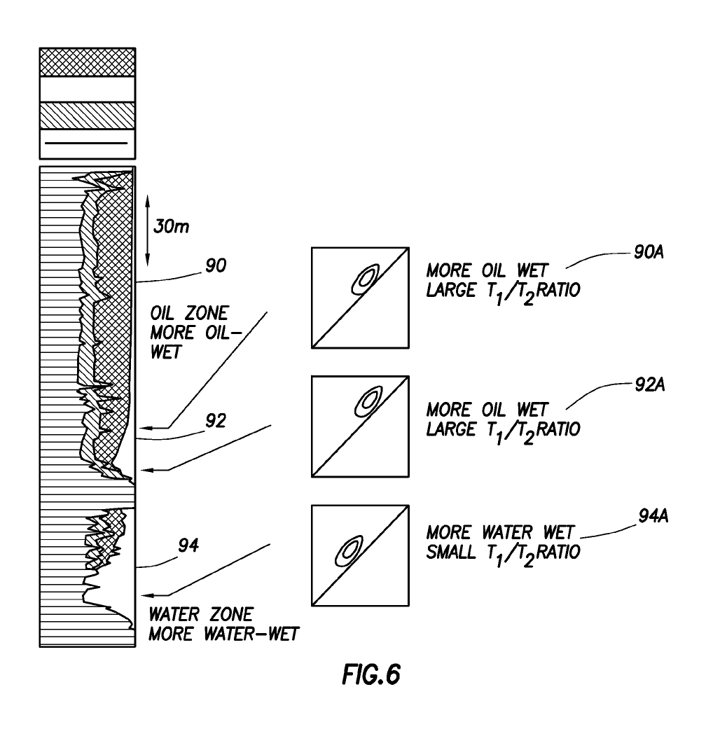

There are a number of different ways to detect the presence of slow motion by NMR measurements. First, it is possible to measure the T₁/T₂ ratio at the Larmor frequency of the well logging instrument. FIG. 6 shows examples of T₁−T₂ measurements of three different rock formations with similar pore geometry, but different wettability. These are shown at 90, 92 and 94, respectively, as a graph of rock volume and pore volume filled with oil and water. The T₁/T₂ ratio, shown respectively at 90A, 92A and 94A is significantly larger for the more oil-wet rocks than for mainly water-wet rock. The wettability may be obtained, for example, from inversion—recovery—CPMG measurements in a fringe field arrangement. Such measurements can be performed with a well logging instrument, but can be rather time consuming.

Alternative methods for measuring T₁/T₂ ratio in a more efficient manner may include the following. A example method includes measuring T₂ relaxation times using the CPMG sequence and varying the echo timing (tE) systematically. The analysis of the T₁/T₂ ratio can be used to detect the presence of motion that is slow compared to the Larmor frequency, which is typically in the MHz range. When the CPMG sequence is used to measure the transverse relaxation time, the measurement averages out any motion slower than the echo spacing tE. In this case, the term J(O) in the expression for T₂⁻¹ should be replaced by (2π/tE). Therefore, by changing the echo spacing tE systematically, it is possible to probe the low frequency behavior of J(ω) in the range of a few hundreds of Hertz to a few tens of kHz. One possible complication of using this approach in well logging applications is the presence of inhomogeneous magnetic fields. Diffusion of spins in such inhomogeneous magnetic fields leads to low frequency fluctuations that also give rise to tE dependent T₁ measurements, but that are not related to wettability. These effects have to be calibrated in order to detect wettability changes with this particular technique.

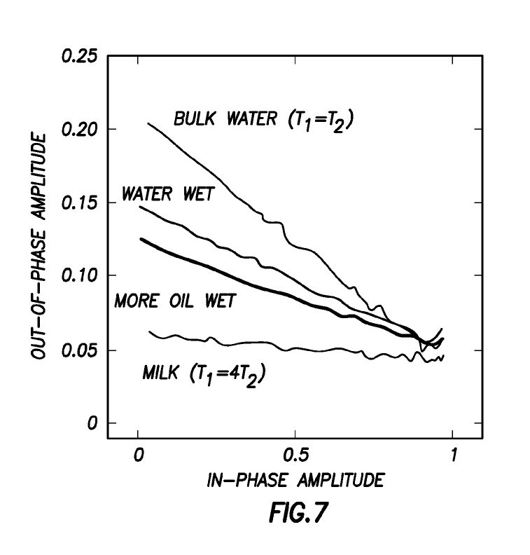

A particularly fast technique of measuring the T₁/T₂ ratio for wettability indication is so-called split-180 degree measurements. The 180 degree spin axis reorienting pulses of a standard Can Purcell Meiboom Gill (CPMG) NMR pulse sequence are each split into two 90 degree spin axis reorienting pulses, separated by a selected short time tau 1. The foregoing pulse sequence generates two types of spin echo signals: an in-phase signal that decays with time and an out-of-phase signal that builds up with time. The ratio of the amplitudes of the final out-of-phase signal to the initial in-phase signal is directly related to the T1/T2 ratio. This allows making the determination of the T₁/T₂ ratio using one-dimensional measurements. FIG. 7 shows results for the same three brine saturated samples as were shown in and explained with reference to FIG. 6. In FIG. 7, the amplitudes of the out-of-phase signal are plotted versus that of the in-phase signal. Both the intercept at the ordinate or the slope of the results are directly linked to the T₁/T₂ ratio.

In a further aspect of the invention, NMR measurements may be used to determine relative saturations (fractional amount of the total volume of pore space) of rock formation filled with water and oil with improved accuracy as compared to methods known in the art. In the interpretation of D-T2 maps for the determination of saturation known in the art, contributions with a diffusion coefficient of bulk water at the relevant conditions are identified as water, those contributions that fall on the diagonal oil line are identified as hydrocarbon. In practice, one often does not measure the full distribution of the diffusion coefficients for a given relaxation time, but only the so-called DCLM (log mean value of the diffusion coefficient). In a simplified manner, this can be written as follows: The DCLM at a given relaxation time is determined from the weighted sum of the diffusion coefficient of water (Dw) and of hydrocarbon (Doil) at this relaxation time:

DCLM=Sw Dw+(1−Sw)Doil (Eq. 13)

where Sw is the water saturation and (1−Sw) corresponds to the oil saturation.

The saturation is estimated from the DCLM by the following procedure: if the measured DCLM coincides with the water value, then the water saturation is 100% and the oil saturation is 0%. In the other limiting case, if the DCLM agrees with the expected oil diffusion coefficient at that relaxation time, then the oil saturation is 100%. If the measured value falls between these two limits, then it is assumed to be possible to compute Sw from the measured value of DCLM using equation (13) above. The foregoing is the procedure known in the art. See, for example, Heaton, et al., Saturation and Viscosity from Multidimensional Nuclear Magnetic Resonance Logging, SPE Paper No. 90564, SPE International, Richardson, Tex. (2004).

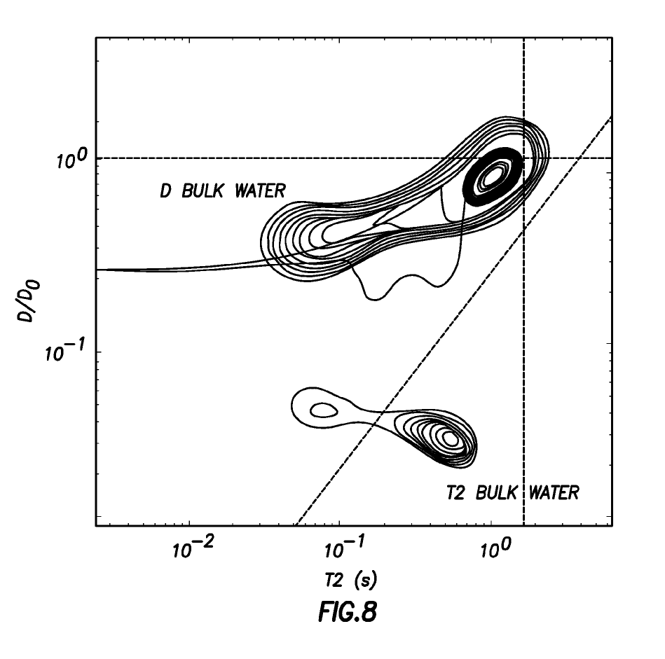

In the present aspect of the invention, it has been determined that the correct determination of Sw depends on determining Dw more accurately than has been previously practiced. In the prior art methods, it has been assumed that Dw corresponds exactly to the diffusion coefficient of water measured at the appropriate temperature and pressure. This assumed value is written as D0 in Equations (3) to (8) above. However, the value Dw of the diffusion coefficient that should be used in the above Eq. (13) or the equations shown in the Heaton et al. publication cited above is affected by restricted diffusion and the value will depend on the relaxation time as a result. It has been determined that a relaxation dependent, restricted diffusion value of Dw may be obtained (as values of D(T2)) using Eq. (7) explained above. An optimum value of the surface relaxivity may be obtained as explained above with reference to FIG. 5. The values of D(T2) thus determined may be substituted for the constant value of DO used in the saturation calculations explained in the Heaton et al. publication to obtain a more accurate value of saturation from the NMR measurements. FIG. 8 shows an example saturation determination using the restricted diffusion value of Eq. (7). For a value of peff=6 μm/s the calculated oil saturation is 12% as compared to a laboratory determined value of 15%. Using a fixed value for the diffusion constant of water and a value of peff=6 μm/s the calculated oil saturation 24% which is considerably higher than the laboratory determined 15%. It is apparent that using a restricted diffusion value for the value of the diffusion constant for water will provide improved accuracy in saturation determination using NMR measurements.

An important consideration in determining saturation using the above method is the diffusion length used in Eq. (7). As can be observed in Eq. (7), the Padé interpolation formula depends on the diffusion encoding length L_{D}, which is the typical distance that a spin traverses during the encoding time T_{EL}. In laboratory diffusion measurements, the amount of relaxation is varied by varying the strength of the magnetic field gradient, while keeping the diffusion length unchanged. This method is referred to as the pulsed-field gradient technique and is the preferred method of measuring the diffusion coefficient as it precisely defines the diffusion period. In typical well logging NMR measurements, however, the gradient is fixed by the geometry of the tool magnets and generally cannot be varied. The necessary change in relaxation due to diffusion can be obtained by varying the encoding time. The kernel used in the inversion routine to determine saturation is appropriate for free diffusion or diffusion motionally averaged over homogeneous regions of pore space. However, the kernel is not designed to account for restricted motion in general. Thus, its effect will be to smear out and broaden the distribution of diffusion coefficients and to find a distribution of diffusion coefficients where there might only be a single diffusion coefficient. Conceptually, the simplest approach to eliminating this artifact would be to change the inversion kernel to include the effects of restriction. To do this rigorously, however, would be non-trivial, as it would involve replacing the value D₀T³_{EL} in the presently used inversion kernel with double time integrals of the Padé diffusion coefficient. Moreover, because the Padé diffusion coefficient in Eq. (7) depends on T2, this procedure would mix together the two inversion dimensions, D and T2, thereby substantially complicating the inversion algorithm. Finally, in the case of mixed water and hydrocarbon saturation, the form of the Padé line would likely be different for water, oil, and gas, due to different fluid arrangements within the pore spaces of the rock and different effective surface relaxivities. Thus, it is not clear that a given choice of kernel would be appropriate to invert a mixed-fluid system. One can, however, make a simple correction to the Padé formula which does not fix the spreading of the distribution but adjusts the water line to correspond more closely to the diffusion coefficient that would be measured with the NMR pulse sequence implemented in the well logging instrument (see FIG. 1 and FIG. 2). The procedure hinges on using a single effective encoding time Td,eff in the Padé expression for D(t) instead of a multiplicity of T_{EL}s. It has been determined that an effective encoding time can be determined by the following expression:

T_{d,eff}=C(\sqrt{T_{EL,avg}})² (Eq. 14)

in which T_{EL,avg} represents the average encoding length. While the coefficient of proportionality in Eq. (22) is only approximate, it should be invariant for different sets of T_{EL}s, and the scaling of Td,eff with T_{EL} should be quite general. Thus, once the constant is calibrated by simulations for one set of T_{EL}s, it can be used to obtain the Td,eff for the other T_{EL}s without the need for further simulations.

It should be noted that the surface relaxivity p defined above in Eq. (4) is determined from the surface relaxation time T_{2,S}. Bulk relaxation must be subtracted from from the total measured relaxation as shown:

1/T_{2,s}=(1/T₂)−(1/T_{2bulk}) (Eq. 15)

If the water in the measurement zone is clean in-the sense of being largely free of paramagnetics and free radicals, its T2 relaxation will follow the temperature dependence of distilled water. T1 measurements of water at standard pressure, over the temperature range from 0° C. to 100° C., are reported in the literature and can be fit with a quadratic polynomial expression to determine Tl at temperatures above 100° C.:

T1_{clean}(T)=1.5004+0.0687T+0.000324T² (Eq. 16)

T2_{clean} may be assumed to be approximately equal to T1_{clean} for purposes of the present method. T represents temperature in degrees C. and T 1 or T2 are in seconds. This procedure will introduce little error, since for such long relaxation times, bulk relaxation will be dominated by other tool-related and environmental effects. Factors such as the presence of oxygen, such as ¹⁷O (oxygen-17), pH, pressure and the amplitude of the static magnetic field (and corresponding Larmor frequency) affect the relationship between T1 and T2 but the foregoing have effects which in the present method may be considered as negligible. However, if drilling is performed with water-based mud, then the invasion of mud filtrate may substantially reduce the measured relaxation times, especially when paramagnetic additives, such as magnesium or barite, are mixed in to adjust the drilling fluid. properties. In such case it is desirable to have a surface measurement of the mud filtrate bulk T2 together with the surface temperature. The same formula in Eq. (16) can be used, to a reasonable approximation, except it needs to be shifted by the right factor to match the given T2-temperature pair. If oil-based mud is used, or no special dopants are added to the mud, the clean water formula Eq. (16) should be used. If the invasion profile is known then the right mix of connate water relaxation Eq. (16) and mud filtrate relaxation as explained above should be used.

High salt concentrations will depress the bulk diffusion coefficient of water. In many important reservoirs, salinities can reach up to 30%. At such high concentrations the bulk diffusion coefficient may be reduced by up to 40% from the corresponding distilled water value. The precise dependence on salinity will be a function of the mixture of salts in the brine, with larger molecules such as magnesium chloride (MgCl) having a greater effect than smaller ones such as sodium chloride (NaCl). However, on the per gram basis, the differences are not as significant as per molecule. In absence of a detailed brine composition, one can use the data available in the literature for NaCl. An expression that may be used to correct the bulk diffusion constant of water for salt concentration is:

D(c)=D(0)[1−0.0726c] (Eq. 17)

where c is the concentration of NaCl in mol/liter and D(0) is the bulk diffusion coefficient of fresh water. It can be assumed that all the temperature dependence is contained in D(0) and that the variation with salt concentration is substantially temperature invariant. If the brine composition is known, however, one can make a more precise inference of D(c) by using published data on other salts, such as NaI, BaCl₂, MgCl₂, KI, and KCl.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining wettability of rock formations using nuclear magnetic resonance measurements, comprising:
determining relaxation properties from nuclear magnetic resonance measurements of the rock formations;
determining a diffusion property of the rock formations from the nuclear magnetic resonance measurements;
determining an effective surface relaxivity of the formation from the relaxation properties and the diffusion property; and
determining wettability from the effective surface relaxivity.

2. The method of claim 1 wherein the effective surface relaxivity is determined by comparing a surface relaxivity measured in a fully water saturated formation with a surface relaxivity measured in a formation of interest.

3. A method for determining wettability of rock formations using nuclear magnetic resonance measurements, comprising:
determining a transverse relaxation time of the rock formation from the nuclear magnetic resonance measurements;
determining a longitudinal relaxation time of the rock formation from the nuclear magnetic resonance measurements;
determining wettability by comparing the longitudinal relaxation time to the transverse relaxation time.

4. The method of claim 3 wherein the longitudinal relaxation time is determined by inversion recovery measurements.

5. The method of claim 3 wherein a ratio of longitudinal relaxation time to transverse relaxation time is determined by performing a plurality of Carr-Purcell-Meiboom-Gill spin ecno sequence measurements on tne formation wnerein an ecno time is systematically varied between sequences.

6. The method of claim 3 wherein a ratio of longitudinal to transverse relaxation time is determined by performing a Carr Purcell Meiboom Gill (CPMG) sequence, wherein 180 degree reorientation pulses in the CPMG sequence are split into two 90 degree reorientation pulses separated by a selected time, wherein spin echoes resulting from each of the split pulses are used to determine an in-phase signal amplitude and an out of phase signal amplitude, the ratio related to the amplitudes of the in-phase signal and the out of phase signal.

7. A method for determining a surface relaxivity of a subsurface rock formation using nuclear magnetic resonance measurements made from within a wellbore penetrating the rock formation, comprising:
determining relaxation properties from the nuclear magnetic resonance measurements;
determining a diffusion property of the rock formation from the nuclear magnetic resonance measurements;
determining the surface relaxivity of the rock formation from the relaxation properties and the diffusion property.

8. The method of claim 7 wherein the diffusion property is related to a molecular diffusion constant of a fluid disposed in pore spaces of the rock formation.

9. The method of claim 8 further comprising determining a Padé interpolated formulation of the diffusion property.

10. The method of claim 7 wherein the nuclear magnetic relaxation properties comprise transverse nuclear magnetic relaxation properties.

11. The method of claim 7 wherein the nuclear magnetic relaxation times comprise longitudinal nuclear magnetic relaxation properties.

12. A metnoa tor aetermining a surface relaxivity of a subsurface rock formation, comprising:
moving a nuclear magnetic resonance well logging instrument along a wellbore drilled through the subsurface rock formation;
measuring nuclear magnetic resonance properties of the rock formation using the instrument;
determining nuclear magnetic relaxation properties from the measurements of the measured nuclear magnetic resonance properties;
determining a diffusion parameter from the measured nuclear magnetic resonance properties; and
determining the surface relaxivity of the rock formation from the relaxation properties and the diffusion parameter.

13. The method of claim 12 wherein the diffusion parameter with respect to relaxation time is related to a molecular diffusion constant of a fluid disposed in pore spaces of the rock formation.

14. The method of claim 13 further comprising determining a Padé interpolated formulation of the diffusion property.

15. The method of claim 12 wherein the nuclear magnetic relaxation properties comprise transverse nuclear magnetic relaxation properties.

16. The method of claim 12 wherein the nuclear magnetic relaxation properties comprise longitudinal nuclear magnetic relaxation properties.

17. The method of claim 12 wherein the moving the instrument comprises moving an armored electrical cable through the wellbore, the instrument disposed proximate one end of the cable.

18. The method of claim 12 wherein the moving the instrument comprises moving a pipe through the wellbore, the instrument coupled within the pipe.

19. The method of claim 12 further comprising determimng a depth of the well logging instrument in the wellbore while the moving and measuring is performed and making a record with respect to depth in the wellbore of the surface relaxivity.

20. A method for determining saturation of water and hydrocarbon in a subsurface rock formation using nuclear magnetic resonance (NMR) relaxation time measurements and diffusion constant measurements, comprising:
determining relaxation properties of the rock formation from the NMR relaxation time measurements;
determining diffusion properties of the rock formation from the NMR diffusion constant measurements; and
inverting the relaxation properties and the diffusion properties to determine the saturation of hydrocarbon and water, the inversion accounting for restricted diffusion.

21. The method of claim 20 wherein the relaxation properties comprises transverse relaxation properties.

22. The method of claim 20 wherein the measurements are obtained by moving a NMR well logging instrument along an interior of a wellbore drilled through the rock formation.

23. The method of claim 22 wherein the well logging instrument is moved by an moving armored electrical cable through the wellbore.

24. The method of claim 22 wherein the well logging instrument is moved by moving a pipe through the wellbore.

25. The method of claim 20 further comprising correcting the relaxation properties for bulk relaxation of water.

26. The method of claim 20 further comprising correcting the diffusion properties for bulk diffusion of water corrected for at least one of temperature and salt concentration.

27. The method of claim 20 wherein the diffusion properties are related to a diffusion length.

28. The method of claim 21 wherein the diffusion length is approximated by a relationsnip or effective diffusion time with respect to encoding length.
